(19) United States
(12) Patent Application Publication
(10) Pub. No.: US 2002/0191775 A1
(43) Pub. Date: Dec. 19, 2002

(54) System and method for personalizing content presented while waiting

(75) Inventors: Stephen J. Boies, Mahopac, NY (US); William Grey, Millwood, NY (US); Paul Andrew Moskowitz, Yorktown Heights, NY (US); Clifford A. Pickover, Yorktown Heights, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/884,658

(22) Filed: Jun. 19, 2001

(51) Int. Cl. H04M 3/00; H04M 5/00

(52) U.S. Cl. 379/266.01; 379/265.02

(57) ABSTRACT

A method, program and system for providing customized information to a user waiting in a queue in a communications system are provided. The invention comprises receiving a communication from a user and placing the user in a queue. The user is then identified. For example, a user using a telephone who has been placed on hold might be identified by the originating telephone number or a customer identification number entered by the user. A database of customized information content is consulted and information content is selected according to user's identity. The customized information content is then presented to the user, either audibly (i.e. over a speaker) or visually (i.e. on a computer or cell phone display). Examples of the type of information content presented to the user include music clips based on caller preferences, local news, or advertisements.

### BACKGROUND OF THE INVENTION

1. Technical Field

The present invention relates generally to communications systems, and more specifically to users waiting in queues.

2. Description of Related Art

Individuals frequently need to wait prior to receiving a service. For example, a user placing a telephone call for customer service is often put on hold prior to speaking with a customer service representative. During this wait, the recipient of the call frequently plays music or provides other forms of entertainment or information over the line. Current embodiments of this process employ a one-size-fits-all approach, presenting the same content to the user no matter who has placed the call. It is worth noting that although being placed on hold prior to speaking with a customer service representative is one of the most common forms of waiting, and one that is familiar to all, it is not the only one. Other examples include waiting for software applications to load, waiting for software updates to be installed, waiting while software utilities such as virus checkers and disk scanners complete processing, waiting for e-mail systems to send and receive messages, waiting for e-mail applications and groupware applications to synchronize or replicate, waiting for a database query to complete processing, waiting for a web page to load, etc. In some cases, there is existing art for presenting material during such waits. Examples of this include so-called “interstitial ads” which are displayed prior to loading a web page, and advertising and marketing material that is sometimes presented while prepackaged software applications are being installed. However, as in the case of auditory content presented while a telephone caller is on hold, current embodiments employ a one-size-fits-all approach, presenting the same material no matter who is waiting. See U.S. Pat. No. 6,014,439 entitled “Method and Apparatus for Entertaining Callers in a Queue”.

Therefore, a method for customizing the content of information presented to a user who is waiting in a queue would be desirable.

### SUMMARY OF THE INVENTION

The present invention provides a method, program and system for providing customized information to a user waiting in a queue. The invention comprises receiving a communication from a user and placing the user in a queue. The user is then identified. For example, the user might be identified by the originating telephone number or user ID, an account identifier, a biometric identifier, a device identifier, a software identifier, geographical positioning data, a speech recognition system, a user password, or a customer identification number entered by the user. A database of customized information content is consulted and information content is selected according to user's identity. The customized information content is then presented to the user, either audibly (i.e. over a speaker), visually (i.e. on a computer screen or cell phone display), or by some other means. Examples of the type of information content presented to the caller include music clips based on caller preferences, local news, the output of software applications, or advertisements.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system diagram illustrating a plurality of interconnected heterogeneous networks in which the present invention may be implemented;

FIG. 2 depicts a block diagram of a data processing system that may be implemented as a server in accordance with a preferred embodiment of the present invention;

FIG. 3 depicts a flowchart illustrating the process of presenting customized information to a caller on hold in accordance with the present invention; and

FIG. 4 depicts a flowchart illustrating the process of identifying a user for purposes of content selection in accordance with the present invention.

### DETAILED DESCRIPTION OF THE PREFERRED EMBODIMENT

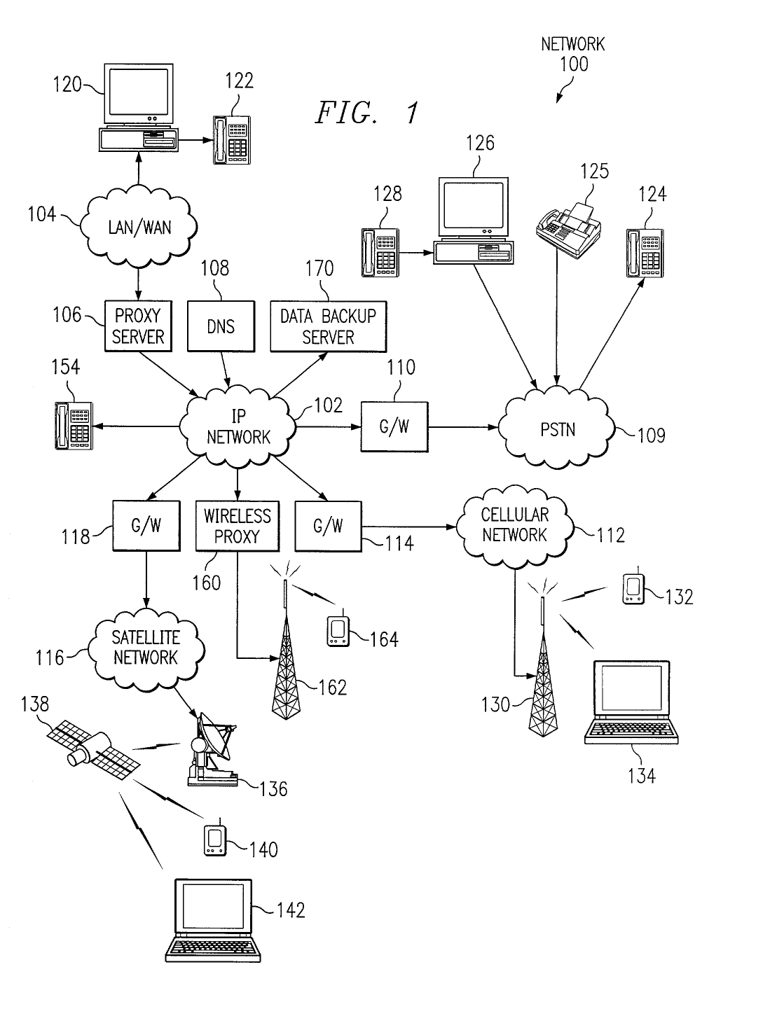

With reference now to the figures, and in particular with reference to FIG. 1, a system diagram illustrating a plurality of interconnected heterogeneous networks in which the present invention may be implemented is depicted. As illustrated, an Internet Protocol (IP) network 102, a Local Area Network (LAN)/Wide Area Network (WAN) 104, the Public Switched Telephone Network (PSTN) 109, a cellular wireless network 112, and a satellite communication network 116 make up the plurality of heterogeneous networks serviced by the personal mobility system of the present invention.

IP network 102 may be the publicly available IP network, a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper 152 is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families. WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4×10-character display with 16-gray levels and only a numeric keypad plus up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118. Wireless Proxy 160 is coupled to IP network 102 and is coupled to a plurality of towers, e.g., 162, which each provide wireless communications with wireless devices such as wireless device 164. Wireless Proxy 160 provides access to IP network 102 to wireless device 164, such as a personal digital assistants (PDA) or a wireless telephone, that may require proprietary or other special protocols in order to communicate with IP network 102. For example, wireless proxy server 160 may be a 3Com server utilizing 3Com protocols for communicating with a Palm VII, a handheld portable computing device available from 3Com Corporation in Santa Clara, Calif.

In a preferred embodiment of the present invention, wireless proxy 160 is a 3Com proxy server supporting communications with Palm VII personal organizer and portable computing device 164 is a Palm VII personal organizer. In this embodiment, communications between wireless proxy server 160 and portable computing device 164 is facilitated by the use of Palm Query Applications (PQAs). A PQA is like a mini-Web site that resides on portable computing device 164. That is, a PQA is a special kind of record database. A typical PQA contains an HTML form or a list of hyperlinks that request additional information either locally—on personal computing device 164—or remotely—on the Internet.

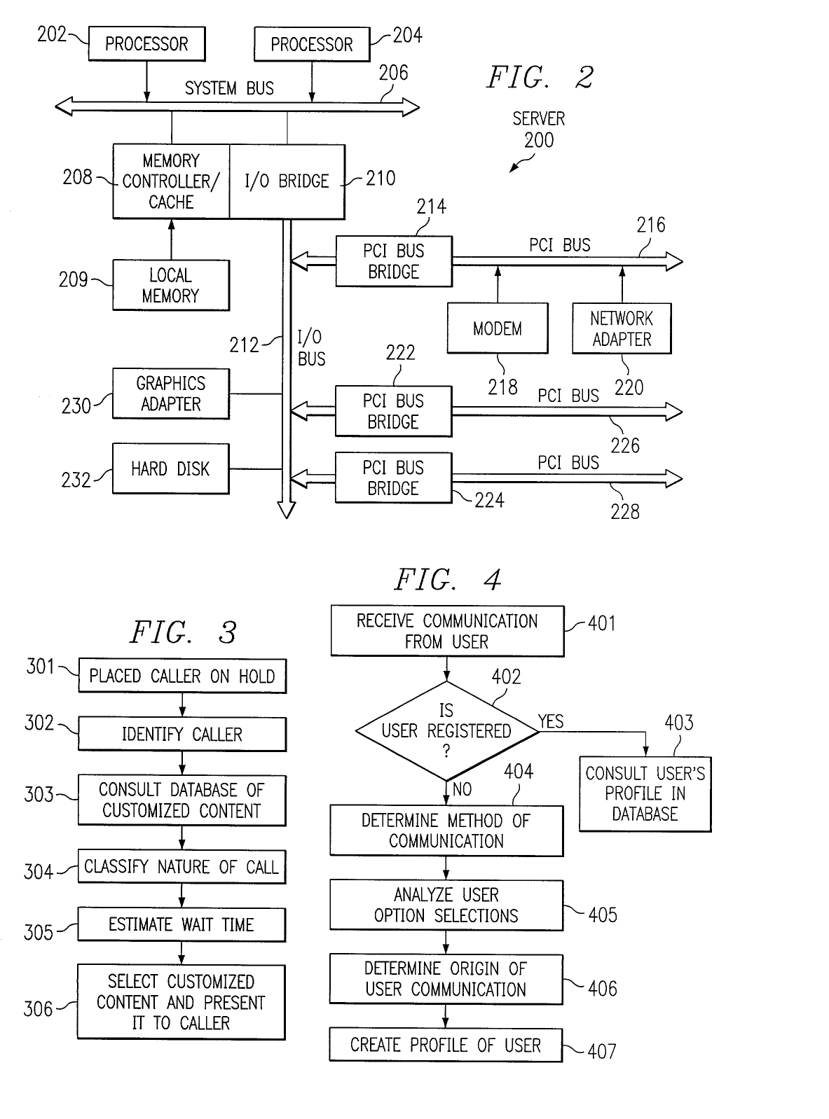

Referring to FIG. 2, a block diagram of a data processing system that may be implemented as a server is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

Referring to FIG. 3, a flowchart illustrating the process of presenting customized information to a user in a queue is depicted in accordance with the present invention. The present invention provides a method for customizing the content presented to user waiting in a queue, as in the case for callers who are on hold for a telephone call. Though the following description focuses primarily on telephone calls, the present invention may be applied whenever a user is attempting to communication with another party is placed in a queue (e.g. Internet access).

When a caller is placed on hold (step 301), the system then identifies the caller (step 302). This may be done by a variety of means including, for example: the caller's originating phone number, a customer number, a user identifier, a screen name, an originating domain name, or an originating Internet protocol address. The system then consults a database containing customized content for that caller (step 303). In general, each user has a profile that specifies listening preferences. Examples of preferences include style of music, type of news (i.e. local or national), favorite radio station, type of game, type of productivity application, type of synthesized speech, type of sporting event, type of television show, type of film, type of audio book, type of shopping preference, type of hobby, type of digital content, type of software applications, references to other sources of customized information, type of electronic book, type of entertainment performance, and e-commerce preferences for personalized advertisements. If the caller does not have a registered profile within a database (which is likely), additional methods may be used to help approximate default content based on the information that is gathered while the caller is on the line.

If the caller is unknown, simple demographic information about the caller could be used to help determine information content. For example, if the user is calling from New York City, local news from a popular New York radio station could be presented. In this example, the customer database would contain preferences based on caller location, rather than a profile for a specific individual. This example could function as a default option, whether using a local customer profile or a third party service provider. Such a default option would be important considering that a high percentage of callers to a busy firm are unlikely to have previously stored preferences.

Next, the nature of the call is determined (step 304). The nature of the call will help determine the type of content to select from the database. For example, someone calling the technical support line is most likely in the process of trying to solve a problem and would appreciate listening to relaxing music. As another example, someone calling the sales line might be interested in hearing advertisements for new products. Determining the nature of the call may also help the system select proper information content when the caller is unknown and does not have an established profile of content preferences. Many firms have voice menus that assist in directing a caller to the right department within the firm. The information gleaned from the options chosen from the menu may not only help refine the content selection for known customers but may also be used to define a rough “sketch” of an unknown caller, which can then be used in selecting content from a database of default contents.

As an option, the system may also estimate the waiting time of the caller (step 305). For example, a caller would not want to hear a news story or comedy clip that is interrupted before the end.

The database may provide a pointer to customized information content or could stream the information directly to the customer. In addition, the database may also provide suggestions about the type of information content that would be appropriate to present to the user. Appropriate information content is selected and then presented to the caller (step 306). The selection of content may be based on the identity of the user, membership of the user within a specified class, the profile of preferences registered by the user, the geographic origin of the communication, the estimated length of time in the hold queue, membership of the user in a class of individuals, demographic information about the user, psychographic information about the user, a profile of preferences ascertained from behavior of the user, time of day of the communication, date of the communication, the type of communication device originating the communication, information ascertained from behavior of the user, place of residence of the user, place of employment of the user, and any other parameter a firm may wish to use. The information content may be presented audibly, visually, or tactilely, depending on the means by which the user is communicating with the system.

The database of customized content can be implemented in a number of ways. One embodiment would rely on an internal database maintained on a local server by the firm itself. Firms with large volumes of calls (especially from repeat and long-term clients) might choose to register customer profiles within a local database. These profiles could be registered when customers first open an account with the firm, and might provide valuable information that could help with targeted marketing. The degree to which a firm customizes the information presented to callers will depend on the nature of the firm and the type of caller traffic received. For example, businesses with a high percentage of repeat customers may wish to cater to individual customers, as mentioned above.

An alternative approach would rely on a third party service provider with profiles of subscribers, which could then be referenced by a firm when placing a caller on hold. The use of a third party database would probably be the more convenient and cost effective approach. Telecommunications customers would subscribe with a single service provider. When the customer calls a firm and is placed on hold, the firm's telecommunications system (having identified the customer) would automatically look up the customer's account with the third party service provider.

The primary advantage of relying on a third party service provider is that callers do not have to set up profiles of preferences with a multitude of firms. Instead, a customer need only set up one profile of content preferences, which other firms would then access should the customer be placed on hold. This also eliminates the cost and trouble of each firm having to set up its own database of customer profiles. Maintaining a single set of preferences also helps to avoid repeating content by maintaining a record of what information has recently been presented to a particular customer. By having content preference data under central control, it is also easier to update and modify the database as new forms of user preferences are identified, and as user preferences change over time.

Referring to FIG. 4, a flowchart illustrating the process of identifying a user for purposes of content selection is depicted in accordance with the present invention. This process enables the system to deal with both registered and unknown users. When the system receives a communication from a user (e.g. phone call or URL request) (step 401), it determines whether or not the user has a registered profile (step 402). This is accomplished using the identification methods described above. If the user is registered, the system simply looks up the user's profile in the database (step 403). However, if the user is not registered, the system approximates the probable interests of the user by means of demographic information gathered about the user.

The system determines the means by which the user is communicating (step 404). The type of device employed by the user (e.g. cell phone, PDA, computer) might be used as a demographic parameter. The user's selection of menu options may also be analyzed to collect more detailed information about the user (step 405). For example, as explained above, the voice menu options of a customer service line can be used to determine the nature of the call as well as areas of user interest. The same concept can be applied to Internet users navigating through a web site's options.

The system may also rely on the origin of the user communication in gathering demographic information about the user (step 406). As noted above, the location of the user may help the system in narrowing information content to local news, sports and other forms of entertainment specific to the user's region.

From the information gleaned in steps 404-406, the system can create a demographic profile of the user (step 407). This profile can then be used to select content from the database.

It should be noted that steps 404-406 may also be used in conjunction with registered profiles and are not limited to use with unregistered users. In addition, steps 404-406 do not have to be in any particular order; the order chosen is simply for the purpose of illustration. Depending on the needs of a firm, any one or combination of steps 404, 405 or 406 may be used in classifying unregistered users.

In another embodiment of the present invention, an interrupt-driven system (perhaps with electronic handshake) could be used to detect the start and end of the hold period. This latter approach would allow the caller to attend to other matters while on hold. An example would be a caller using a computer employing voice over Internet Protocol (IP) or a wireless phone with Internet access.

In yet another embodiment, information about the nature of the content could be used to customize the length of time the user is actually waiting in the queue. For example, if the system estimated that the wait time in queue would be five minutes, it might present a comedy clip that was four and a half minutes in duration. However, actual call volumes at a call center might result in a customer service representative being available to attend the user more quickly than originally estimated. In such cases, the system could delay removal of the user from the queue until such time as the comedy clip had concluded.

For certain devices, such as personal computers and smart phones, the customized content could take the form of a pre-specified, default content source. For example, a user with a smart phone who is placed on hold could set up a default source that specifies listening to his or her favorite MP3 files while waiting to speak to a customer service representative. It could also identify a local file, set of files, or folder to reference that could either provide information about content to display, or contain actual content. These files or folders could either be local to the user device, or accessed via a communications network. On initiating the telephone hold, the system would send a message to the device to play the user's default content. It could also send an interrupt message that could be processed by a user device to enable the display of personalized content determined by a local application, or by communication to another client device or server. Just before the hold is terminated, an interrupt message would be sent to the device indicating that the hold was over. The user's attention would then be redirected to the outbound telephone call, where he or she could then speak with the customer service representative. For this and other embodiments the transition from listening to music to interacting with the customer representative could be eased by a number of means, such as fading out the music, or continuing to play it in the background.

It should be noted that the method of the present invention is not limited to callers using telephones or personal computers. The present techniques could also be employed wherever people are required to wait for service. Examples include supermarket lines (where visual or auditory content could be targeted at particular individuals), or waiting at a tollbooth.

The description of the present invention has been presented for purposes of illustration and description, and is not intended to be exhaustive or to limit the invention to the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing customized information to a user placed in a queue, comprising:
receiving a communication from a user;
placing the user communication in a queue;
identifying the user;
consulting a database of customized information content;
receiving a response from the database according to user identity; and
presenting customized information content to the user.

2. The method according to claim 1, wherein the response received from the database comprises customized information content.

3. The method according to claim 1, wherein the response received from the database comprises a pointer to customized information content.

4. The method according to claim 1, wherein the response received from the database comprises suggestions about the type of information content that would be appropriate to present to the user.

5. The method according to claim 1, wherein the communication is by means of at least one of the following:
a telephone;
a personal computer;
a portable computer;
a mobile or fixed user station;
a workstation;
a network terminals or server;
a cellular telephone;
a dumb terminal;
a personal digital assistant;
a two-way pager;
a smart phone;
a information appliance;
a network computer;
a kiosk; and
a PDA.

6. The method according to claim 1, wherein the queue is a telephone hold queue.

7. The method according to claim 1, wherein the user is identified by means of at least one of the following:
an originating telephone number;
a customer identifier;
an account identifier;
a biometric identifier;
a device identifier;
a software identifier;
geographical positioning data;
a speech recognition system;
a user password;
a user identifier;
a screen name;
an originating domain name; and
an originating Internet protocol address.

8. The method according to claim 1, further comprising:
estimating the length of time the user will be in the queue.

9. The method according to claim 1, wherein the database of customized information content is maintained on at least one of the following:
a local server;
a remote server; and
a local device.

10. The method according to claim 1, wherein the database of customized information content is maintained by a third party.

11. The method according to claim 1, wherein the customized information content is selected according to at least one of the following means:
the identity of the user;
membership of the user in a class of users;
a profile of preferences registered by the user;
membership of the user in a class of individuals;
demographic information about the user;
psychographic information about the user;
a profile of preferences ascertained from behavior of the user;
time of day of the communication;
date of the communication;
the type of communication device originating the communication;
information ascertained from behavior of the user;
place of residence of the user;
place of employment of the user;
the geographic origin of the communication; and
the estimated length of time in the hold queue.

12. The method according to claim 1, wherein the customized information content includes at least one of the following categories:
news;
music preference;
music;
game;
productivity application;
synthesized speech;
sporting event;
television show;
film;
audio book;
hobby;
shopping preference;
advertisement;
digital content;
software applications;
references to other sources of customized information;
electronic book; and
clip of entertainment performances.

13. The method according to claim 1, further comprising:
allowing the user to communicate with other parties while in the queue.

14. The method according to claim 1, further comprising:
sending an interrupt message to a device in conjunction with presenting the customized information content to the user.

15. The method according to claim 1, further comprising:
sending an interrupt message to a device when the user is removed from the queue.

16. The method according to claim 1, wherein the customized information content is presented by means of at least one of the following methods:
audible;
visual; and
tactile

17. The method according to claim 1, wherein the nature of the information content is used to determine the length of time the user communication is kept in the queue.

18. A computer program product in a computer readable medium for use in a data processing system, for providing customized information to a user placed in a queue, the computer program product comprising:
instructions for receiving a communication from a user;
instructions for placing the user communication in a queue;
instructions for identifying the user;
instructions for consulting a database of customized information content;
instructions for receiving a response from the database according to user identity; and
instructions for presenting customized information content to the user.

19. The computer program product according to claim 18, wherein the response received from the database comprises customized information content.

20. The computer program product according to claim 18, wherein the response received from the database comprises a pointer to customized information content.

21. The computer program product according to claim 18, wherein the response received from the database comprises suggestions about the type of information content that would be appropriate to present to the user.

22. The computer program product according to claim 18, wherein the queue is a telephone hold queue.

23. The computer program product according to claim 18, wherein the user is identified by means of at least one of the following:
an originating telephone number;
a customer identifier;
an account identifier;
a biometric identifier;
a device identifier;
a software identifier;
geographical positioning data;
a speech recognition system;
a user password;
a user identifier;
a screen name;
an originating domain name; and
an originating Internet protocol address.

24. The computer program product according to claim 18, further comprising:
instructions for estimating the length of time the user will be in the queue.

25. The method according to claim 18, wherein the customized information content is selected according to at least one of the following means:
the identity of the user;
membership of the user in a class of users;
a profile of preferences registered by the user;
membership of the user in a class of individuals;
demographic information about the user;
psychographic information about the user;
a profile of preferences ascertained from behavior of the user;
time of day of the communication;
date of the communication;
the type of communication device originating the communication;
information ascertained from behavior of the user;
place of residence of the user;
place of employment of the user;
the geographic origin of the communication; and
the estimated length of time in the hold queue.

26. The computer program product according to claim 18, wherein the customized information content includes at least one of the following categories:
news;
music preference;
music;
game;
productivity application;
synthesized speech;
sporting event;
television show;
film;
audio book;
hobby;
shopping preference;
advertisement;
digital content;
software applications;
references to other sources of customized information;
electronic book; and
clip of entertainment performances.

27. The computer program product according to claim 18, further comprising:
instructions for allowing the user to communicate with other parties while in the queue.

28. The computer program product according to claim 18, further comprising:
instructions for sending an interrupt message to a device in conjunction with presenting the customized information content to the user.

29. The computer program product according to claim 18, further comprising:
instructions for sending an interrupt message to a device when the user is removed from the queue.

30. The computer program product according to claim 18, wherein the nature of the information content is used to determine the length of time the user communication is kept in the queue.

31. A system for providing customized information to a user placed in a queue, comprising:
a first receiver which receives a communication from a user;
a queuing component which places the user communication in a queue;
an identification component which identifies the user;
a communications component which consults a database of customized information content;
a second receiver which receives a response from the database according to user identity; and
a presenting component which presents the customized information content to the user.

32. The system according to claim 31, wherein the communication is by means of at least one of the following:
a telephone;
a personal computer;
a portable computer;
a mobile or fixed user station;
a workstation;
a network terminals or server;
a cellular telephone;
a dumb terminal;
a personal digital assistant;
a two-way pager;
a smart phone;
a information appliance;
a network computer;
a kiosk; and
aPDA.

33. The system according to claim 31, wherein the queue is a telephone hold queue.
